(19) United States
(12) Patent Application Publication
(10) Pub. No.: US 2013/0192343 A1
(43) Pub. Date: Aug. 1, 2013

(54) KNOCK DETECTION DEVICE OF INTERNAL COMBUSTION ENGINE

(71) Applicants: Toru TANAKA, Chiyoda-ku (JP); Yuhei MATSUSHIMA, Chiyoda-ku (JP); Keitaro EZUMI, Aki-gun (JP); Tomokuni KUSUNOKI, Aki-gun (JP); Atsushi INOUE, Aki-gun (JP); Hiroki MORIMOTO, Aki-gun (JP)

(72) Inventors: Toru TANAKA, Chiyoda-ku (JP); Yuhei MATSUSHIMA, Chiyoda-ku (JP); Keitaro EZUMI, Aki-gun (JP); Tomokuni KUSUNOKI, Aki-gun (JP); Atsushi INOUE, Aki-gun (JP); Hiroki MORIMOTO, Aki-gun (JP)

(73) Assignees: MAZDA MOTOR CORPORATION, Hiroshima (JP); MITSUBISHI ELECTRIC CORPORATION, Tokyo (JP)

(21) Appl. No.: 13/611,944

(22) Filed: Sep. 12, 2012

(30) Foreign Application Priority Data
Feb. 1, 2012 (JP) 2012-019429

(51) Int. Cl. G01L 23/22

(52) U.S. Cl. 73/35.01

(57) ABSTRACT

In order to obtain a knock detection device of an internal combustion engine which satisfies two objects of following capability and separation from a continuous knock generation state, when a background level is calculated by ((current background level)=(filter coefficient)×(previous background level)+(1−filter coefficient)×(output signal from knock sensor)), updating quantity of the background level is limited by ((1−filter coefficient)×(value not lower than maximum value of output signal from knock sensor at time when knock is not generated)).

### BACKGROUND OF THE INVENTION

1. Field of the Invention

The present invention relates to calculation of a background level in a knock detection device of an internal combustion engine in which a background level is calculated based on a detected output signal from a knock sensor, a knock determination value is led out from the background level, and knock determination is performed.

2. Description of the Related Art

An engine etc. that runs on gasoline ignites and burn air-fuel mixture in a cylinder by a spark from an ignition plug during combustion stroke; however, when pressure in the cylinder is abnormally increased in the middle of flame propagation after ignition, a knock in which an unburned portion of the air-fuel mixture is self-ignited may generate before the flame propagation is completed. Then, a problem exists in that, when the knock is generated, vibration which gives a sense of discomfort to occupants is generated and, in the worst case, the upper surface of a piston is melted and damaged to break down the engine. Consequently, there has been conventionally proposed knock control in which, when the knock is generated, ignition timing of an ignition plug is retarded to eliminate the knock and optimum torque and fuel consumption are achieved.

In the knock control, a vibration detection sensor so-called a knock sensor is equipped on a cylinder block in order to detect the generation of the knock and a vibration waveform of the engine, which is detected by the knock sensor, is analyzed to determine the presence or absence of the generation of the knock. More specifically, a predetermined crank angle range after ignition, in which a vibration waveform can be obtained if the knock is generated, is regarded as a knock determination period; and an output signal from the knock sensor is analog/digital (A/D) converted in the knock determination period and a peak value is regarded as a peak hold value in the knock determination period. Then, a background level is calculated by performing smoothing processing of the peak hold value. Furthermore, the background level is performed as much as predetermined times (for example, two times) to set a knock determination value.

Then, the knock determination value is compared to the peak hold value; and when the peak hold value exceeds the knock determination value, a determination is made that knocking is generated and elimination operation of the knock is performed, for example, the ignition timing of the ignition plug is retarded. In order to perform such knock determination operation, the background level needs to be properly found. Conventionally, limitation of updating quantity is reduced during transition while stabilizing by limitation processing of updating quantity of the background level and accordingly following capability is secured.

In Patent Document 1, an upper limit value of updating quantity is increased in response to an increase of a variation of fuel injection quantity per hour or a variation of a throttle opening degree while stabilizing by setting the upper limit value to the updating quantity of the background level; and accordingly, the background level is converged to the peak hold value immediately. Furthermore, as the related art in Patent Document 1, an upper limit value of updating quantity is increased in response to an increase of a variation of the number of revolutions per hour of an engine or a variation of intake manifold pressure; and accordingly, the background level is converged to the peak hold value immediately. This object is to provide countermeasures against a phenomenon in that, when a load of the engine is increased, the peak hold value is increased in also the case where the knock is not generated, but if stabilization is continued by smoothing processing or limitation processing of updating quantity, the background level is not immediately increased; and as a result, a knock determination value becomes excessively small and therefore the knock is erroneously determined.

### [Patent Document]

[Patent Document 1] Japanese Examined Patent Publication No. 4312164

On the other hand, the knock may generate when the load of the engine is increased; and a very strong knock may continuously generate in some cases. In the case of such a state (referred to as a “continuous knock generation state”), ignition timing needs to be immediately retarded to eliminate the knock. In Patent Document 1, the background level is made to follow immediately when the load is changed; and therefore, the knock determination value is also increased immediately. As a result, in the case of the very strong knock signal, determination cannot be made as to whether or not the knock is generated. Then, separation from the continuous knock generation state described above cannot be made and therefore the knock is continuously generated to cause a serious effect on the engine.

FIG. 1 to FIG. 3 are each a timing chart of the peak hold value, the background level, and the knock determination value. For simplicity, the knock determination value is two times of the background level. FIG. 1 is an example in the case where the knock is not generated when the load of the engine is increased. This drawing shows a behavior in the case where the upper limit value of updating quantity is sufficiently large and update of the background level is not limited.

FIG. 2 is an example where the continuous knock generation state is generated when the load of the engine is increased. This drawing shows a behavior in the case where the upper limit value of updating quantity is large and update of the background level is not limited, which is the object of the related art. As in FIG. 1, the knock determination value is also immediately increased when the load is changed and determination cannot be made as to whether or not the knock is generated. As a result, the continuous knock generation state is continued.

FIG. 3 shows a behavior in the case where the upper limit value of updating quantity of the background level is smaller than the case of FIG. 2 in the same case as the continuous knock generation state of FIG. 2. In this drawing, since the rise of the background level is limited with respect to a very large peak hold value that rushes into the continuous knock generation state, the peak hold value exceeds the knock determination value in rushing and determination is made that the knock is generated; and accordingly, retard is performed. For this reason, the knock state is not continued and the peak hold value can be returned to an adequate level.

As described above, separation from the continuous knock generation state can be made according to setting of the upper limit value of updating quantity and therefore it becomes possible to prevent from causing a serious effect on the engine. That is, the upper limit value of updating quantity needs to be set so as to satisfy two contradictory objects: one object is to secure following capability and the other object is that a large peak hold value like the continuous knock generation state is determined that the knock is generated and retard is performed to separate from the continuous knock generation state. However, Patent Document 1 does not disclose a technique as to how the upper limit value of updating quantity is defined and there is a concern that becomes the behavior of FIG. 2.

### BRIEF SUMMARY OF THE INVENTION

Consequently, an object of the present invention is to provide means, which is for setting an upper limit value of updating quantity that satisfies two objects of following capability and separation from a continuous knock generation state, without increasing man-hours.

According to the present invention, there is provided a knock detection device of an internal combustion engine in which a background level is updated based on an output signal from a knock sensor, a knock determination value is calculated based on the background level, and the generation of a knock is detected by comparing the knock determination value with the output signal from the knock sensor. In the knock detection device of the internal combustion engine, when the background level is calculated by ((current background level)=(filter coefficient×previous background level)+(1−filter coefficient)×(output signal from knock sensor)), updating quantity of the background level is limited by ((1−filter coefficient)×(value not lower than maximum value of output signal from knock sensor at time when knock is not generated)).

Furthermore, the maximum value of the output signal from the knock sensor at the time when the knock is not generated is defined depending on the internal combustion engine speed.

Further, the output signal from the knock sensor is a peak hold value of the output signal from the knock sensor.

According to a knock detection device of an internal combustion engine of the present invention, a large change like a continuous knock generation state can be limited while securing following capability, that is, separation from the continuous knock generation state can be achieved.

The foregoing and other object, features, aspects, and advantages of the present invention will become more apparent from the following detailed description of the present invention when taken in conjunction with the accompanying drawings.

### BRIEF DESCRIPTION OF THE SEVERAL VIEWS OF THE DRAWINGS

FIG. 1 is a timing chart for explaining knock determination and is an example in the case where a knock is not generated;

FIG. 2 is a timing chart for explaining knock determination and is an example of a continuous knock generation state;

FIG. 3 is a timing chart for explaining knock determination and is an example that is separated from a continuous knock generation state;

FIG. 4 is a view showing an adaptation method of a maximum value L of a peak hold value of the present invention;

FIG. 5 is a view showing other adaptation method of a maximum value L of a peak hold value of the present invention;

FIG. 6 is a configuration view showing an internal combustion engine equipped with a knock control device using a knock detection device according to Embodiment 1 of the present invention;

FIG. 7 is a block diagram showing the configuration of the knock control device using the knock detection device of the internal combustion engine according to Embodiment 1;

FIG. 8 is a block diagram showing the configuration of the knock control unit of the knock control device of the internal combustion engine according to Embodiment 1;

FIG. 9 is a flowchart of the knock control unit of the knock control device of the internal combustion engine according to Embodiment 1;

FIG. 10 is a view showing an example of an adaptation value which defines a maximum value L of a peak hold value according to Embodiment 2; and

FIG. 11 is a flowchart of a step which calculates the maximum value L of the peak hold value according to Embodiment 2.

### DETAILED DESCRIPTION OF THE INVENTION

First, major techniques of the present invention will be described.

A background level obtained from an output signal of a knock sensor of an internal combustion engine is calculated by primary filter calculation of a peak hold value of the output signal of the knock sensor. Incidentally, the peak hold value of the output signal of the knock sensor may be even an integral value (the area of the higher potential side than the center of vibration) of the output signal of the knock sensor; what matters is that the peak hold value may be a value corresponding to the output signal of the knock sensor. This is represented in the following equation:

VBGL(n)=K×VBGL(n−1)+(1−K)×VP(n)

where
VBGL(n): background level,
VP(n): peak hold value,
K: filter coefficient, and
n: processing timing (discrete time).
   The filter coefficient K is a constant, a value that depends on the number of revolutions of the internal combustion engine, or the like, which is the filter coefficient K defined by a knock detection device intended to be applied to the present invention.

Furthermore, data of peak hold values at the time when the knock is not generated in various operation states and loads of the internal combustion engine are measured and the maximum value L thereof is obtained. Then, updating quantity of the background level is limited by an upper limit value of updating quantity ((1−K)×L). Then, the former equation is represented in the following equation:

VBGL(n)=min(K×VBGL(n−1)+(1−K)×VP(n),

VBGL(n−1)+(1−K)×L) Equation (1)

where
L: maximum value of peak hold value, and
min (A, B): select either smaller one of A and B.
   The background level VBGL(n) is defined as described above.

Further, the maximum value L from the knock sensor at the time when the knock is not generated may be defined depending on the number of revolutions of the internal combustion engine (the internal combustion engine speed).

According to the knock detection device of the internal combustion engine having the aforementioned major techniques of the present invention, limitation can be given to a large change like a continuous knock generation state while securing following capability as follows, that is, separation from the continuous knock generation state can be achieved.

When a difference with a processing timing (n−1) of the background level is defined as

ΔVBGL(n)=VBGL(n)−VBGL(n−1)

with respect to a primary filter calculation portion of Equation

VBGL(n)=K×VBGL(n−1)+(1−K)×VP(n), (1)

the following equation is obtained:

$$\begin{matrix}Δ VBGL ( n ) = K ( n ) \times VBGL ( n - 1 ) + ( 1 - K ( n ) ) \times VP ( n ) - \\ K ( n - 1 ) \times VBGL ( n - 2 ) - ( 1 - K ( n - 1 ) ) \times \\ VP ( n - 1 ) .\end{matrix}$$

Incidentally, the filter coefficient K is defined to be intended to be applied to the present invention; and therefore, the filter coefficient K may depend on processing timing and is expressed as K(n).

In order to lead out an equation which gives an upper limit of ΔVBGL(n), before the load of the internal combustion engine is increased, if the peak hold value is 0 constant, that is,

VBGL(n‘2)=VBGL(n−1)=VP(n−1)=0,

the above equation is represented in the following equation:

ΔVBGL(n)=(1−K(n))×VP(n).

Incidentally, since the processing timing is only n, K(n) is expressed as K and the following equation is obtained:

ΔVBGL(n)=(1−K)×VP(n) Equation (2).

In this case, if the maximum value L of the peak hold value VP(n) of the knock sensor at the time when the knock is not generated is set in place of VP(n),

ΔVBGL(n)≦(1−K)×L

is established in each processing timing n, that is, a maximum variation (updating quantity) of the background level at the time when the knock is not generated is represented as ((1−K)×L)

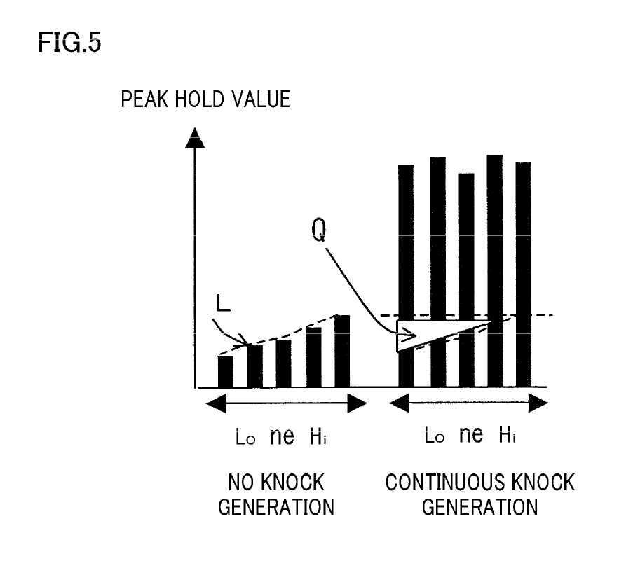

As described above, data of the peak hold values at the time when the knock is not generated in various operation states and loads of the internal combustion engine are obtained and the maximum value thereof is set as L, which will be described using FIG. 4.

FIG. 4 is a typical view in which maximum values of the peak hold values are graphically shown in the following cases: one is the case where the knock is not generated and the other is in the case of the continuous knock generation state, which are extracted from the measured results of the peak hold values in various operation states and loads of the internal combustion engine, and both cases are further classified by the number of revolutions ne of the internal combustion engine, respectively.

The maximum value L of the aforementioned peak hold values is the maximum value of the peak hold values in the case where the knock is not generated; and therefore, the maximum value is defined by the data marked with P shown in FIG. 4. That is, if the knock is not generated in all the number of revolutions ne, the peak hold values are always smaller than L.

Consequently, if the maximum value L of the peak hold value is set in place of VP(n) in Equation (2), ((1−K)×L) is obtained as the maximum value of ΔVBGL(n) in the case where the knock is not generated.

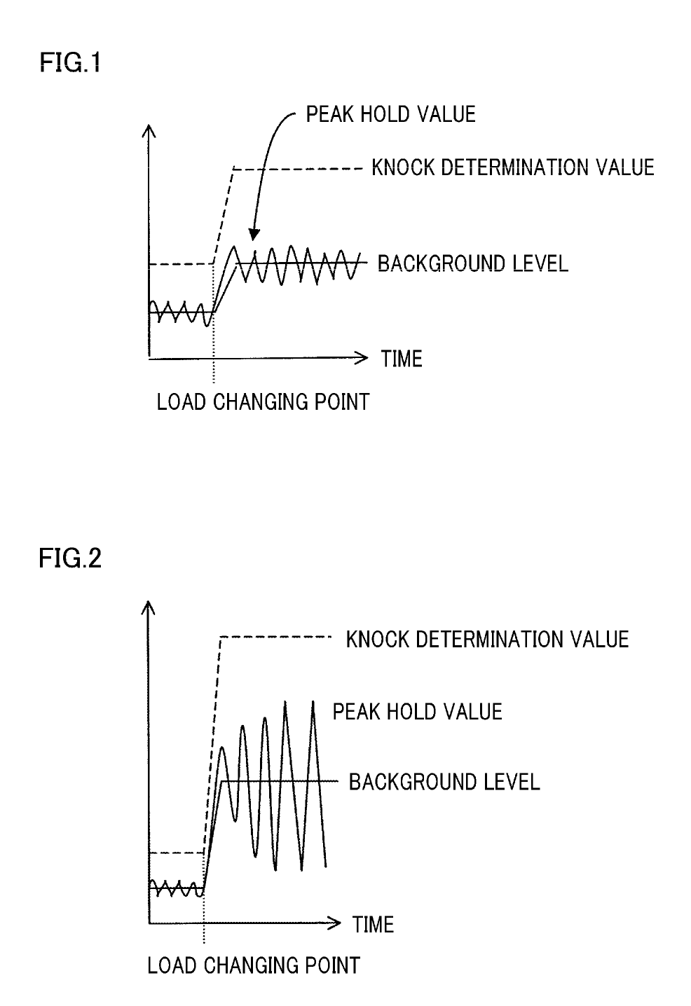

From the above, if ((1−K)×L) is set as the upper limit value of updating quantity of the background level, the upper limit value is always larger than the variation of the background level in the case where the knock is not generated; and therefore, the rise of the background level is not limited, that is, following capability is maintained. A response waveform of FIG. 1 can always be achieved.

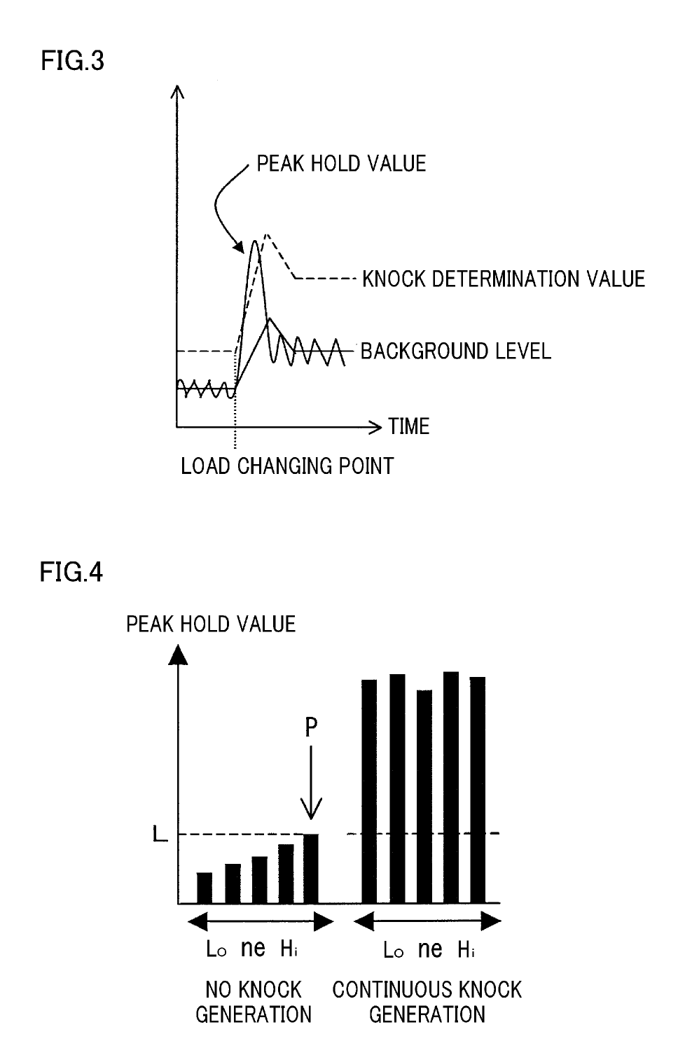

On the other hand, as shown in FIG. 4, in the case of the continuous knock generation state, the maximum value of the peak hold value is not lower than L; and accordingly, the rise of the background level can be limited by the upper limit value of updating quantity ((1−K)×L) in the continuous knock generation state. For this reason, as described before, separation from the continuous knock generation state can be achieved. That is, a response waveform of FIG. 2 is not achieved, but a response waveform of FIG. 3 can always be achieved.

Furthermore, new evaluation is not needed for setting L and man-hours is not increased. Because Equation (2) is defined by VP(n), setting can be made from data measured at the time when adapted to usual knock, the data being the peak hold value in the case where the knock is not generated. Consequently, new data for adapting to the present invention does not need to be obtained and setting man-hours is not increased.

Furthermore, the maximum value L of the peak hold value from the knock sensor in the case where the knock is not generated can be set depending on the number of revolutions of the internal combustion engine (the internal combustion engine speed); and therefore, L can be set to be smaller according to the number of revolutions. Accordingly, the knock determination value can be suppressed to be small; and therefore, the knock can be more reliably determined in the continuous knock generation state. FIG. 5 is the case where L in FIG. 4 is set depending on the number of revolutions ne of the internal combustion engine. In a region where the number of revolutions ne is small, the upper limit value of updating quantity ((1−K)×L) is smaller than the upper limit value of updating quantity of FIG. 4 (a portion of Q shown in FIG. 5). For this reason, the gradient of the background level of FIG. 3 is more gradual and the peak hold value readily exceeds the knock determination value. That is, knock determination is readily performed.

### Embodiment 1

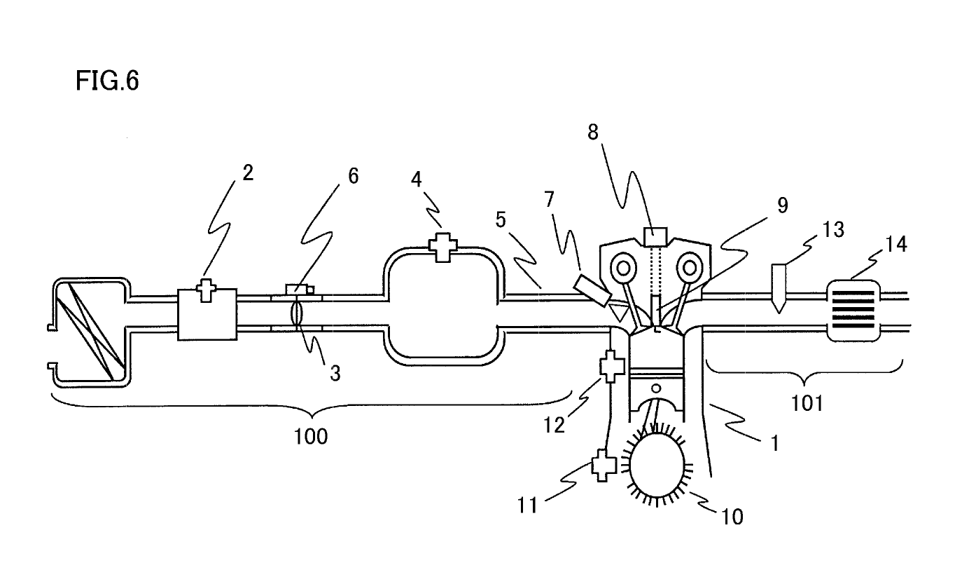

Hereinafter, a knock control device using a knock detection device of an Internal combustion engine according to Embodiment 1 of the present invention will be described with reference to drawings. FIG. 6 is the configuration view schematically showing the internal combustion engine equipped with a knock control device using a knock detection device according to Embodiment 1 of the present invention. Incidentally, an internal combustion engine for vehicles such as an automobile is usually equipped with a plurality of cylinders and pistons; however, for the sake of simplicity of the description, FIG. 6 shows only one cylinder and piston.

In FIG. 6, an intake system 100 of an internal combustion engine 1 includes an air flow sensor 2 which measures intake air flow volume from the upper stream side and sends an intake air flow volume signal corresponding to a measured value thereof, an electronically controlled throttle valve 3 whose opening degree is electronically controlled to adjust intake air flow volume of the intake system 100, and an intake manifold pressure sensor 4 which is provided on a surge tank; and the intake system 100 is connected to a plurality of cylinders of the internal combustion engine 1 through an intake manifold 5.

A throttle position sensor 6 measures the opening degree of the electronically controlled throttle valve 3 and sends a throttle valve opening degree signal corresponding to a measured value of the opening degree. Incidentally, a mechanical throttle valve directly connected with wire to an accelerator pedal (not shown in the drawing) may be used in place of the electronically controlled throttle valve 3. The intake manifold pressure sensor 4 measures intake manifold pressure in the intake manifold 5 and sends an intake manifold pressure signal corresponding to a measured value of the intake pressure. Incidentally, both of the air flow sensor 2 and the intake manifold pressure sensor 4 are provided in Embodiment 1; however, only either one of them may be provided. An injector 7 which injects fuel is provided on an intake port of the intake manifold 5. Incidentally, the injector 7 may be provided so as to be able to directly inject into the cylinder of the internal combustion engine 1.

A cylinder head of the internal combustion engine 1 is provided with an ignition coil 8 which is for igniting air-fuel mixture in the cylinder and an ignition plug 9 connected to the ignition coil 8. Furthermore, a plate 10 provided with a plurality of edges placed at predetermined intervals on the peripheral surface thereof is located on a crankshaft of the internal combustion engine 1. A crank angle sensor 11 is located facing the edges of the plate 10 and detects the edges of the plate 10 which rotates together with the crankshaft and sends a pulse signal in synchronization with the placed intervals of the respective edges. A knock sensor 12 located on the internal combustion engine 1 sends a vibration waveform signal based on the vibration of the internal combustion engine 1. An exhaust system 101 of the internal combustion engine 1 is provided with an oxygen concentration sensor 13 which measures oxygen concentration in exhaust gas and a catalyst device 14 which cleans up the exhaust gas.

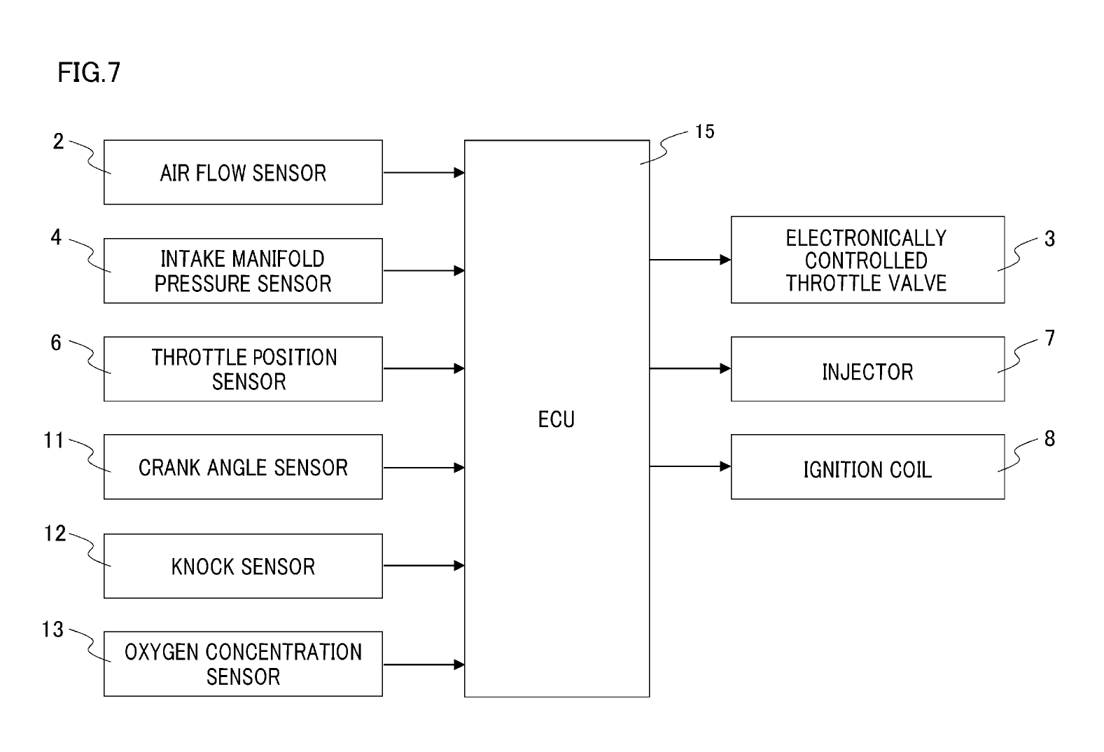

FIG. 7 is a block diagram showing the configuration of the knock control device using the knock detection device of the internal combustion engine according to Embodiment 1. In FIG. 7, an electronic control unit 15 (hereinafter, referred to as an “ECU”) of the internal combustion engine 1 is configured by a calculation device such as a microcomputer and the following signals are applied thereto: the intake air flow volume signal sent from the air flow sensor 2; the intake manifold pressure signal sent from the intake manifold pressure sensor 4; the throttle valve opening degree signal sent from the throttle position sensor 6; the pulse signal sent from the crank angle sensor 11 and synchronized with the placed intervals of the plate 10; the vibration waveform signal of the internal combustion engine 1 sent from the knock sensor 12; and an oxygen concentration signal in the exhaust gas, sent from the oxygen concentration sensor 13.

Furthermore, signals, which are other than the aforementioned respective signals and correspond to respective measured values, are applied to the ECU 15 from also other various sensors (not shown in the drawing). Further, for example, signals sent from other controllers such as an automatic transmission control system, a brake control system, and a traction control system, are also applied thereto.

The ECU 15 calculates a target throttle position based on an accelerator position (not shown in the drawing), an operation state of the internal combustion engine 1, and the like and controls the opening degree of the electronically controlled throttle valve 3 based on the calculated target throttle position. Furthermore, the ECU 15 controls fuel injection quantity by driving the injector 7 so as to achieve a target air-fuel ratio according to the operation state of the internal combustion engine 1. Further, the ECU 15 controls ignition timing by controlling energization to the ignition coil 8 so that target ignition timing is achieved. In addition, the ECU 15 also controls to suppress the generation of a knock by setting the target ignition timing to the retard side as to be described later in the case where the knock of the internal combustion engine 1 is detected. Further, the ECU 15 calculates an indication value which is for controlling various types of actuators other than the before mention to control the various types of actuators based on the indication value.

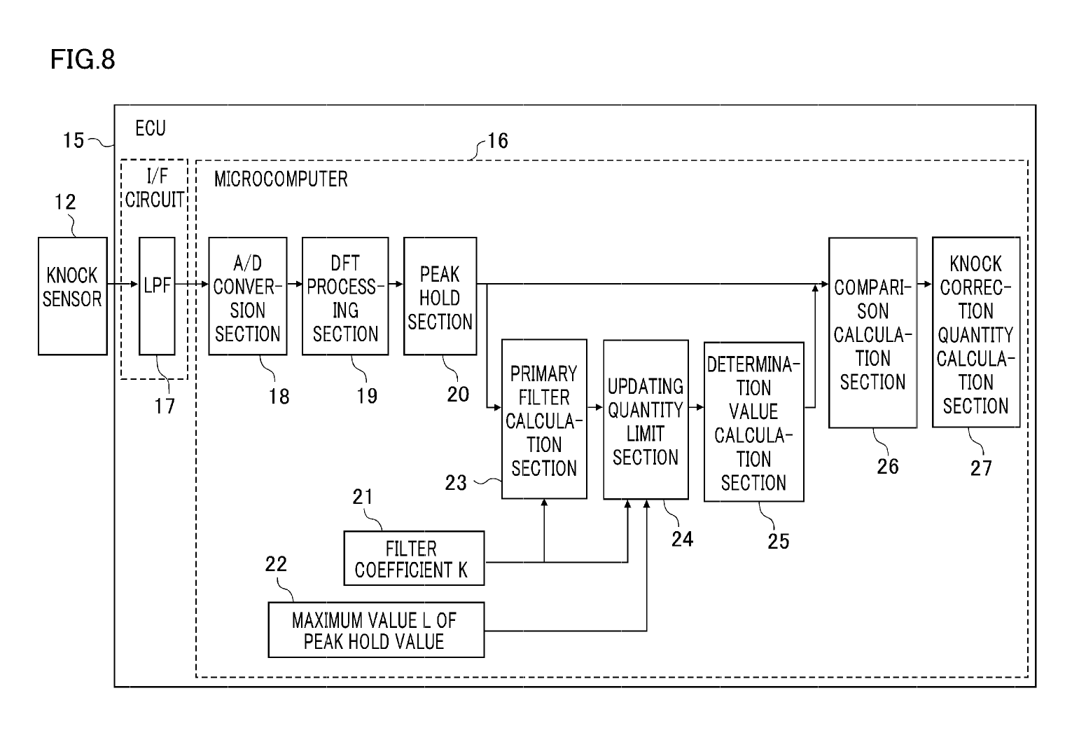

Next, the configuration and operation of a knock control unit configured in the ECU 15 will be described. FIG. 8 is a block diagram showing the configuration of the knock control unit in the knock control device of the internal combustion engine according to Embodiment 1. In FIG. 8, the knock control unit configured in the ECU 15 is composed of an interface (I/F) circuit and a microcomputer 16. The I/F circuit is configured by a low pass filter (hereinafter, referred to as a “LPF”) 17 which receives the vibration waveform signal of the internal combustion engine 1, the vibration waveform signal being sent from the knock sensor 12, and removes a high frequency component from the vibration waveform signal.

The microcomputer 16 as a whole is composed of an analog/digital (A/D) converter which converts an analog signal to a digital signal, a read only memory (ROM) area which stores control programs and control constants, a random access memory (RAM) area which stores variables in the case of executing a program, and the like. The knock control unit includes an A/D conversion section 18, a discrete Fourier transform (DFT) processing section 19, a peak hold section 20, a filter coefficient K of a reference numeral 21, the maximum value L of the peak hold value of a reference numeral 22, a primary filter calculation section 23, an updating quantity limit section 24, a determination value calculation section 25, a comparison calculation section 26, and a knock correction quantity calculation section 27.

The LPF 17, as described before, receives the vibration waveform signal of the internal combustion engine 1, the signal being sent from the knock sensor 12, and removes the high frequency component from the vibration waveform signal. However, the entire vibration components are fetched by the A/D conversion section 18; and therefore, for example, the LPF 17 is configured that a bias of 2.5 V is applied to set the center of the vibration components to 2.5 V and thus the vibration components are fitted in a range of 0 V to 5 V centering on 2.5 V. Incidentally, the LPF 17 includes a gain conversion function which amplifies centering on 2.5 V in the case where the vibration component of the vibration waveform signal from the knock sensor 12 is small, and reduces centering on 2.5 V in the case where the vibration component is large.

The A/D conversion section 18 converts the vibration waveform signal to a digital signal, the vibration waveform signal being sent from the knock sensor and the vibration waveform signal's harmonic components being removed by the I/F circuit. A/D conversion by the A/D conversion section 18 is performed at regular time intervals, for example, at every 10 μs or 20 μs. Incidentally, the A/D conversion section 18 always performs A/D conversion with respect to the analog signal from the LPF 17; and only data during a period at which a knock is generated in the internal combustion engine 1, for example, only data during a knock detection period set from top dead center (hereinafter, referred to as “TDC”) of the piston to a crank angle (CA) of 50° (hereinafter, referred to as “50° CA”) after top dead center (hereinafter, referred to as “ATDC”) may be transferred to the DFT processing section 19. Alternatively, for example, A/D conversion is performed only during the knock detection period set from TDC to 50° CA ATDC and its data may be transferred to the DFT processing section 19.

The DFT processing section 19 performs time-frequency analysis for the digital signal from the A/D conversion section 18. More specifically, a spectrum row of a knock natural frequency component at each predetermined time is calculated by, for example, discrete Fourier transform (DFT) or short time Fourier transform (STFT). Incidentally, as for digital signal processing by the DFT processing section 19, the knock natural frequency component may be extracted using an infinite impulse response (IIR) filter or a finite impulse response (FIR) filter. The OFT processing section 19 starts processing after the completion of A/D conversion during the aforementioned knock detection period by the A/D conversion section 18 and terminates the processing until interrupt processing of crank angle synchronization which performs processing by the knock correction quantity calculation section 27 from the peak hold section 20 (to be described later), for example, until interrupt processing at a 75° CA before top dead center (hereinafter, referred to as “BTDC”).

The peak hold section 20 calculates a peak hold value of the spectrum row calculated by the DFT processing section 19. The filter coefficient K of the reference numeral 21 sends the value of K to the primary filter calculation section 23 and the updating quantity limit section 24. The filter coefficient K, may be the filter coefficient K in which the knock detection device intended to be applied to the present invention defines as described before. For example, the filter coefficient K may be 0.9 if a constant.

As for the maximum value L of the peak hold value of 22, a previously adapted predetermined value is sent to the updating quantity limit section 24, as explained in FIG. 4. The primary filter calculation section 23 performs primary filter calculation with respect to the peak hold value calculated by the peak hold section 20 using the filter coefficient K of 21. The updating quantity limit section 24 limits with respect to the result of the primary filter calculation by the sum of the previous output value and the upper limit value of updating quantity ((1−K)×L) using the filter coefficient K of 21 and the maximum value L of the peak hold value of 22 and sends as the background level. The primary filter calculation section 23 and the updating quantity limit section 24 correspond to the aforementioned Equation (1).

The determination value calculation section 25 calculates a knock determination value by Equation (3) represented as follows:

VTH(n)=VBGL(n)×Kth+Vofs Equation (3)

where
VTH(n): knock determination value,
Kth: determination value coefficient, and
Vofs: determination value offset.
   The determination value coefficient Kth and the determination value offset Vofs are previously adapted values so that the knock determination value VTH(n) is larger than the peak hold value VP(n) when the knock is not generated and the knock determination value VTH(n) is smaller than the peak hold value VP(n) when the knock is generated. For example, the determination value coefficient Kth is 2 and the determination value offset Vofs is 0.

The comparison calculation section 26 compares the peak hold value VP(n) calculated by the peak hold section 20 with the knock determination value VTH(n) calculated by the determination value calculation section 25 and calculates a knock intensity VK(n) by Equation (4) represented as follows:

VK(n)=VP(n)−VTH(n) Equation (4)

where
VK(n): knock intensity.

The knock correction quantity calculation section 27 updates knock correction quantity θR(n) based on the knock intensity VK(n) calculated by the comparison calculation section 26. That is, if the knock intensity VK(n) is larger than zero (VK(n)>0), a determination is made that the knock is generated and the knock correction quantity θR(n) is updated by Equation (5) represented as follows:

θR(n)=min(max(θR(n−1)−θrtd, θmin), θmax) Equation (5),

where
θR(n): knock correction quantity,
θrtd: updating quantity during retard,
θmin: lower limit value of knock correction quantity,
θmax: upper limit value of knock correction quantity, and
max(A, B): either larger one of A and Bis selected.
   The θrtd, θmin, and θmax are predetermined values previously defined by adaptation or values defined depending on the knock intensity VK(n) or the like. These values may be values in which the knock detection device intended to be applied to the present invention defines.

Furthermore, if the knock intensity VK(n) is equal to or smaller than zero (VK(n)≦0), a determination is made that the knock is not generated and the knock correction quantity θR(n) is updated by Equation (6) represented as follows:

θR(n)=min(max(θR(n−1)θadv, θmin), θmax) Equation (6),

where
θadv: updating quantity during advance.
   The updating quantity during advance θadv is also a predetermined value previously defined by adaptation or a value defined depending on the knock intensity VK(n) or the like. These values may be values in which the knock detection device intended to be applied to the present invention defines.

The microcomputer 16 in the ECU 15 calculates final ignition timing θIG(n) using the knock correction quantity θR(n) calculated as described before, by Equation (7) represented as follows:

θIG(n)=θB(n)+θR(n) Equation (7)

where
θIG(n): final ignition timing, and
θB(n): basic ignition timing.
   The basic ignition timing θB(n) is also a predetermined value previously defined by adaptation and this value may be a value in which the knock detection device intended to be applied to the present invention defines. Incidentally, also with regard to all the knock correction quantity θR(n), the basic ignition timing θB(n), and the final ignition timing θIG(n), the advance side is positive and the retard side is negative.

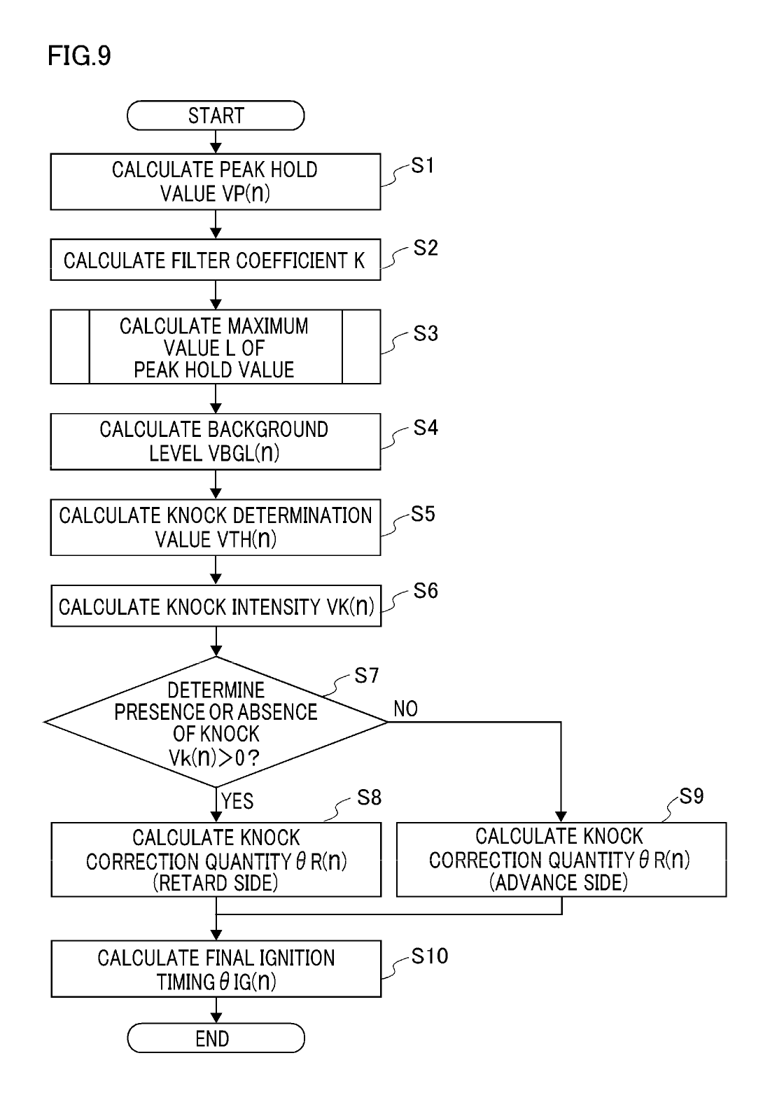

The configuration of the knock control unit configured in the ECU 15 has been described. Incidentally, the knock detection device in FIG. 8 is composed of the knock sensor 12, the low pass filter 17, the A/D conversion section 18, the DFT processing section 19, the peak hold section 20, the filter coefficient K of 21, the maximum value L of the peak hold value of 22, the primary filter calculation section 23, the updating quantity limit section 24, the determination value calculation section 25, and the comparison calculation section 26. Next, the operation of the knock control unit will be shown using FIG. 9. FIG. 9 is a flowchart of the knock control unit in the knock control device of the internal combustion engine according to Embodiment 1. Processing shown in FIG. 9 is performed by the interrupt processing of the crank angle synchronization, for example, by the interrupt processing at 75° CA BTDC, as described before.

The peak hold value VP(n) is calculated in step S1. The peak hold value VP(n) is a value in which the maximum value of the spectrum row calculated by the DFT processing section 19 is sent by the peak hold section 20 as described before. The filter coefficient K is calculated in step S2. The filter coefficient K is a previously adapted constant, a value depending on the number of revolutions of the internal combustion engine, or the like. The maximum value L of the peak hold value is calculated in step S3. In Embodiment 1, the maximum value L of the peak hold value is the previously adapted predetermined value as described in FIG. 4.

The background level VBGL(n) is calculated in step S4. The background level VBGL(n) is calculated by the aforementioned Equation (1) by the primary filter calculation section 23 and the updating quantity limit section 24. The knock determination value VTH(n) is calculated in step S5. The knock determination value VTH(n) is calculated by the aforementioned Equation (3) by the determination value calculation section 25. The knock intensity VK(n) is calculated in step S6. The knock intensity VK(n) is calculated by the aforementioned Equation (4) by the comparison calculation section 26.

The knock intensity VK(n) calculated by the aforementioned step S6 is compared to 0 in step S7 which is included in the knock correction quantity calculation section 27. The processing is advanced to step S8 when the knock intensity VK(n) is larger than zero (VK(n)>0) or advanced to step S9 when other than that (VK(n)≦0). The knock correction quantity θR(n) at the time when the knock is generated, is updated by the aforementioned Equation (5) in step S8 which is included in the knock correction quantity calculation section 27. The knock correction quantity θR(n) at the time when the knock is not generated, is updated by the aforementioned Equation (6) in step S9 which is included in the knock correction quantity calculation section 27. The final ignition timing θIG(n) is calculated in step S10. The final ignition timing θIG(n) is calculated by the aforementioned Equation (7). Then, ignition is performed according to θIG(n). That is, advanced and/or retarded ignition timing can be achieved depending on the knock determination result. Embodiment 2.

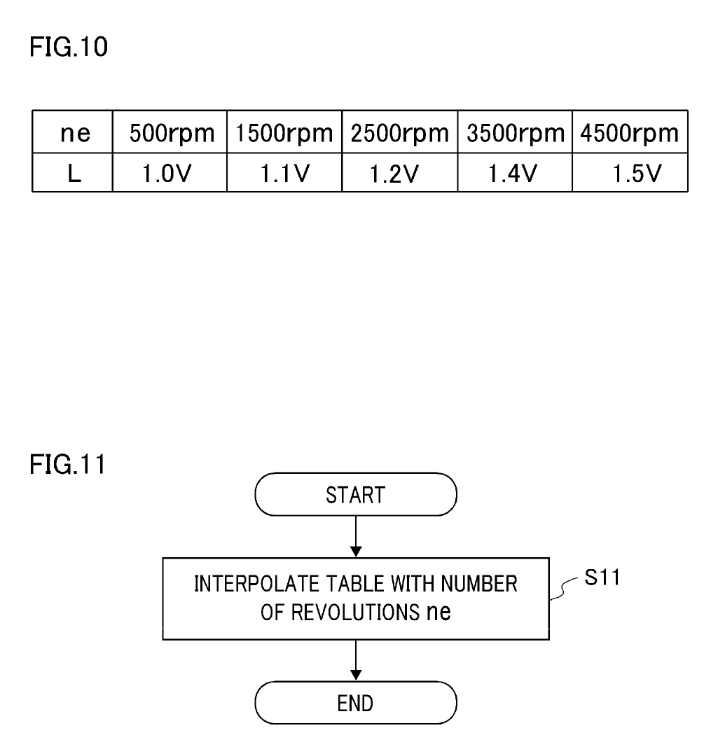

A knock detection device of an internal combustion engine according to Embodiment 2 will be described. The different point between Embodiment 2 and Embodiment 1 is a method of calculating a maximum value L of a peak hold value; and therefore, only this portion will be described. The maximum value L of the peak hold value is defined depending on the number of revolutions ne of the internal combustion engine. In the method of setting L, as in Embodiment 1, data of peak hold values in various operation states and loads of the internal combustion engine in which a knock is not generated are obtained and maximum values thereof are classified by the number of revolutions ne of the internal combustion engine to set as table data. This is L shown in FIG. 5 and, for example, is set as FIG. 10.

In the maximum value L of the peak hold value of 22 of FIG. 8, the table of FIG. 10 is interpolated with the number of revolutions ne; and its result is used as the maximum value L of the peak hold value of Equation (1) in the updating quantity limit section 24. The maximum value L of the peak hold value is calculated in step S3 of FIG. 9; however, in Embodiment 2, calculation is performed according to FIG. 11. FIG. 11 is a flowchart of a step which calculates the maximum value L of the peak hold value of the knock control unit in the knock detection device of the internal combustion engine according to Embodiment 2.

After step S2 of FIG. 9, the processing is advanced to step Sll of FIG. 11. In step S11, the table of FIG. 10 is interpolated with the number of revolutions ne of the internal combustion engine to calculate the maximum value L of the peak hold value. Then, the processing is advanced to step S4 of FIG. 9; and, after that, calculation is performed as in Embodiment 1.

Incidentally, in the present invention, the respective embodiments can be freely combined and appropriately changed or omitted in the scope of the present invention.

What is claimed is:

1. A knock detection device of an internal combustion engine in which a background level is updated based on an output signal from a knock sensor, a knock determination value is calculated based on the background level, and the generation of a knock is detected by comparing the knock determination value with the output signal from the knock sensor,
wherein, when the background level is calculated by
((current background level)=(filter coefficient)×(previous background level)+(1−filter coefficient)×(output signal from knock sensor)),
updating quantity of the background level is limited by
((1−filter coefficient)×(value not lower than maximum value of output signal from knock sensor at time when knock is not generated)).

2. The knock detection device of the internal combustion engine according to claim 1,
wherein the maximum value of the output signal from the knock sensor at the time when the knock is not generated is defined depending on the internal combustion engine speed.

3. The knock detection device of the internal combustion engine according to claim 1,
wherein the output signal from the knock sensor is a peak hold value of the output signal from the knock sensor.

4. The knock detection device of the internal combustion engine according to claim 2,
wherein the output signal from the knock sensor is a peak hold value of the output signal from the knock sensor.
